(19) United States
(12) Patent Application Publication
(10) Pub. No.: US 2014/0048353 A1
(43) Pub. Date: Feb. 20, 2014

(54) AERIAL LADDER SAFETY DEVICE

(71) Applicant: Morgan Todd Ellis, Alachua, FL (US)

(72) Inventor: Morgan Todd Ellis, Alachua, FL (US)

(21) Appl. No.: 13/966,816

(22) Filed: Aug. 14, 2013

Related U.S. Application Data
(60) Provisional application No. 61/683,316, filed on Aug. 15, 2012.

(51) Int. Cl. A62B 35/00

(52) U.S. Cl. CPC A62B 35/005
USPC 182/241

(57) ABSTRACT

A fall restraint device for attachment to an extendable or telescoping ladder platform has a safety rope for attaching a slidable lanyard fixed to a climber. The length of the rope lies on tops of the exposed rungs of the ladder and extends with the ladder as the ladder is deployed and wherein upon retraction of the ladder the rope follows the ladder and toward the base or turntable of the ladder. The lanyard for attachment to a climber of the ladder and for slidable attachment to the safety rope has a locking element at the slidable attachment to the rope. The locking element slides freely unloaded, but locks the lanyard to the safety rope when under load of a falling or slipping climber.

### RELATED APPLICATIONS

The present invention claims benefit of priority to U.S. Provisional Application 61/683,316 entitled “Aerial Ladder Safety Device” filed on Aug. 15, 2012.

### TECHNICAL FIELD

This invention relates to a fall restraint device for attachment to vertically extendible platforms mounted on vehicles, such as an aerial ladder mounted on a fire truck. More particularly, the invention relates to an arrangement for preserving safety in the operation of an aerial ladder or the like while permitting its use while securing a climbing firefighter.

### BACKGROUND OF THE INVENTION

Many safety and maintenance vehicles are equipped with vertically extendible devices to permit operation high above the ground. An example is an aerial ladder carried by a fire truck. These vertically extendible devices must be carefully supported and stabilized for the safety of persons using them. An aerial ladder on a fire truck, for example, is typically mounted on a rotatable base or platform which permits the ladder to be positioned at any point on a circular arc. The fire truck and ladder are stabilized by outriggers deployed outwardly on opposite sides of the truck. Such outriggers usually extend about five feet on each side of the fire truck and provide very good stabilization for any rotational position of the aerial ladder.

The platforms or aerial ladders typically are refracted in stacked sections onto a fire truck such that the length can be reduced while driving. The ladder can have three or more stacked sections that are laid on top of the others. As the ladder is set up vertically, these sections are driven upwardly extending the ladder. When fully extended the ladder can reach 75 to 150 feet or more. The incline of the ladder typically is 60 degrees or more, often almost vertically oriented up to 75 degrees or so. The ladders have rungs onto which the firefighter places his or her feet to upwardly climb. The sides have handrails to help keep the firefighter from falling.

Often the firefighter is laden with heavy equipment while climbing and has much of this weight on his or her back. This magnifies the risk of losing balance and slipping. Once the start of a fall occurs, if the firefighter cannot catch oneself by grasping a rung or handrail, he or she is likely to fall. Too often this fall is fatal due to the extreme heights.

To prevent falling, the firefighter can tie himself or herself to the top of the extended ladder once he or she has climbed that far. Unfortunately, the falls often occur as the firefighter is climbing and to date there has been no way to safely secure the climbing firefighter without impeding his or her rapid ascent.

It is therefore an object of the present invention to provide a safe and simple fall restraint device for use on such aerial ladders that secures the climbing firefighter while not interfering significantly with the climb while allowing safe maneuvering up and down the ladder.

Another objective is to have the device employable with the extension of the ladder.

Another objective is to have the device not interfere with the setting up, extension or refraction of the ladder, but rather to coexist with the ladder and the climber without detrimentally getting in the way of or impeding the operation.

These and other objectives are achieved by the inventive fall restraint device described as follows.

### SUMMARY OF THE INVENTION

A fall restraint device for attachment to an extendable or telescoping ladder platform has a safety rope for attaching a slidable lanyard fixed to a climber. The device has a safety rope, having a first end for attachment to an anchor point on a side of the ladder at an end or top of the ladder and a second end located at or near the base of the ladder held on the same side as the first end. The length of the rope lies on tops of the exposed rungs of the ladder and extends with the ladder as the ladder is deployed and wherein upon retraction of the ladder, the weight of the rope follows the ladder and drops toward the base or turntable of the ladder wherein the rope piles at the base of the ladder and is unsecured from the ladder at the first end and placed in a rope bag or storage container after use.

The second or bottom end of said rope is held taut or otherwise affixed at or near the bottom or base of the extended ladder. In an alternative embodiment, the second or bottom end of the rope is affixed to a windable spool. The spool can be manually wound having a wind up reel for manual winding of the rope back onto the spool. The spool can further include a spring loaded retractable rope spool. The spring tension provides continuous tension or tautness on the rope. Alternatively, the spool can have a spring loaded retractor reel for automatically winding the rope. Preferably, the spool is removably attached to the bottom of the ladder. This allows the spool with the wound rope to be detached from the ladder for stowing.

The fall restraint device further has a lanyard for attachment to a climber of the ladder and for slidable attachment to the safety rope. The lanyard has a locking element at the slidable attachment to the rope. The locking element slides freely unloaded, but locks the lanyard to the safety rope when under load of a falling or slipping climber. The locking element can be a PRUSIK device. The PRUSIK device is a PRUSIK knot in the lanyard. Preferably, the PRUSIK knot is triple wrapped.

### BRIEF DESCRIPTION OF THE DRAWINGS

The invention will be described by way of example and with reference to the accompanying drawings in which:

FIG. 1 is a view of an aerial or platform ladder vehicle with the ladder in a stowed transportable condition.

FIG. 2 is a view of the aerial or platform ladder vehicle with the vehicle shown stabilized with outriggers and the ladder fully extended.

FIG. 3 is a top view of the horizontally stowed ladder showing the fall restraint safety rope attached to an end of the ladder and lying above or on the outer exposed rungs.

FIGS. 4a, 4b and 4c show the ladder inclined vertically as the sections are extended,

FIG. 4a shows the first section upright, FIG. 4b shows the first and second sections extended,

FIG. 4c shows the first, second and third sections extended.

FIG. 5 is an enlarged partial view showing the safety rope having a clasped end fixed to the top end of the ladder.

FIGS. 6a, 6b and 6c show the retraction sequence of the ladder with the safety rope affixed showing the rope piling at the base of the ladder.

FIG. 7 is a view of a lanyard harness for attachment to the safety rope and the ladder climber.

FIG. 7a shows the climber of the ladder secured to the safety rope by the lanyard.

FIG. 8 is an enlarged view of the lanyard locking element.

FIG. 8a is a climber shown suspended by the ladder after falling.

FIG. 9 is a view showing a manual spool with the safety rope for affixing to the base of the ladder.

FIG. 10a shows the safety rope wound separately stowed in a bag when removed from the ladder ready for storing.

FIG. 10b is a view showing the spool with an automatic retractor feature for mounting to a ladder frame or base.

FIG. 11 shows the ladder with a spool mounted to the base.

### DETAILED DESCRIPTION OF THE INVENTION

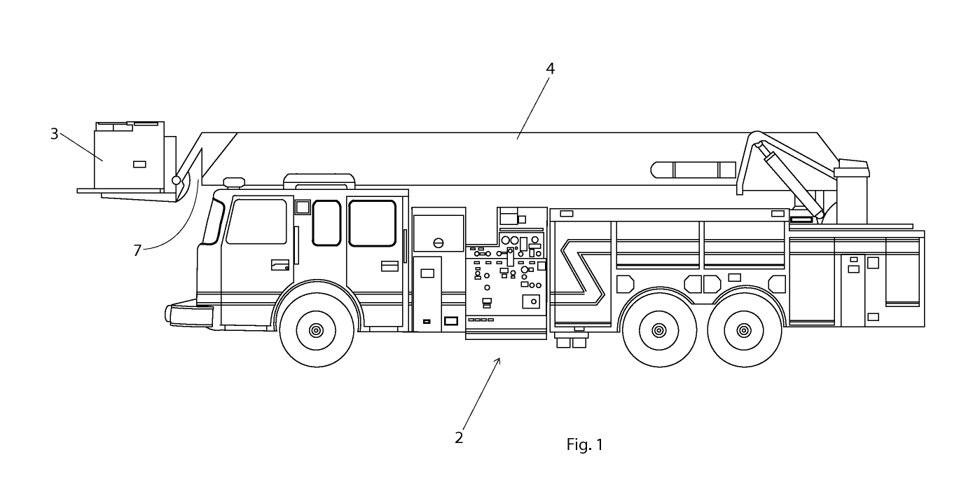

With reference to FIG. 1 an aerial or platform ladder vehicle 2 is shown with the ladder 4 in the stowed or transportable condition. The vehicle 2 has the platform ladder 4 with three or more sections shown stacked on top of the vehicle 2 to which a platform 3 is attached at an end 7 of the ladder 4. This stacked orientation of the ladder 4 enables the ladder 4 to shorten its length so that it can easily be transported to the site where the ladder 4 is needed. In the exemplary vehicle 2 of FIG. 1, the vehicle 2 is a fire truck having an aerial or platform ladder 4 that is used in the fighting of fires.

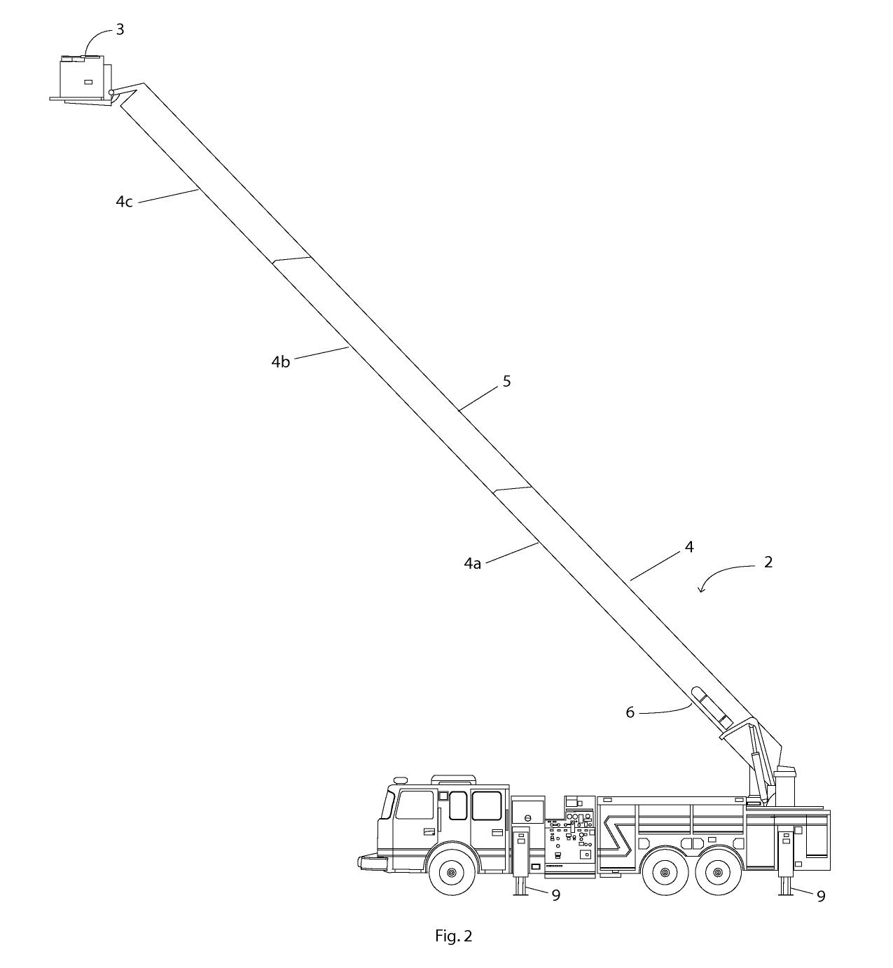

With reference to FIG. 2, the aerial or platform ladder 4 vehicle 2 is shown with stabilized outriggers 9 to stabilize the vehicle 2 with the ladder 4 shown in the fully extended position. As shown when the sections of the ladder 4 are extended, the ladder 4 can reach vertical heights of 75 to 100 feet or more. As shown the ladder 4 has rungs 6 upon which a firefighter can climb up the ladder 4. On each side of the ladder 4 are handrails 5 that help secure the climber and help him or her in the event of a fall. These side handrails 5 extend outwardly from the ladder 4 a sufficient distance such that they provide some protection for the climber. This protection assists the climber in the event that debris or other falling matter should hit the side of the ladder to protect the climber 1 in his vertical ascent.

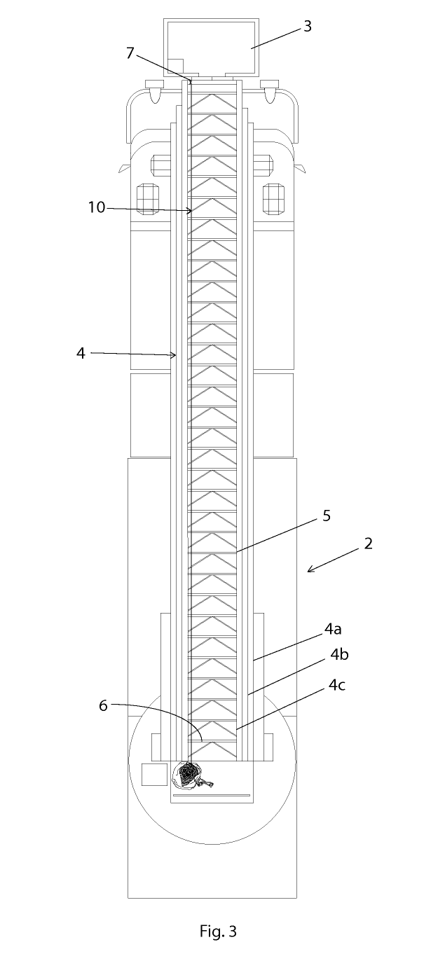

With reference to FIG. 3, a top view of a horizontally stowed platform ladder 4 is shown. In this view, a fall restraint safety rope 10 is shown attached to an end 7 of the ladder 4 and is lying above or on the outer exposed rungs 6 of the ladder 4 when the ladder 4 is in its refracted condition.

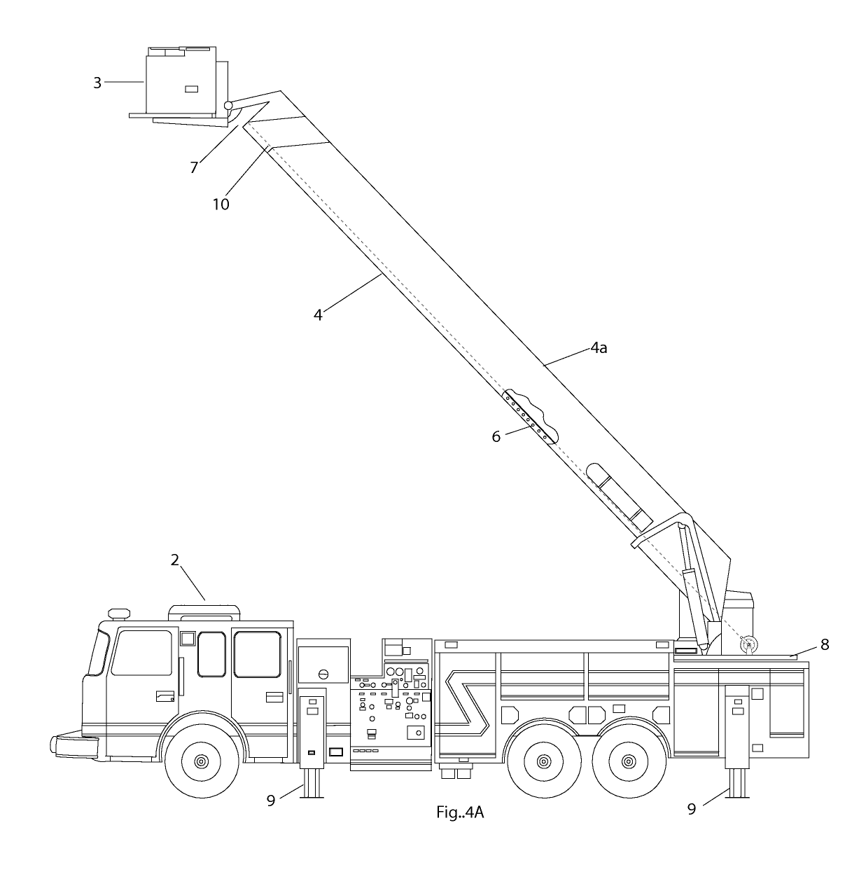

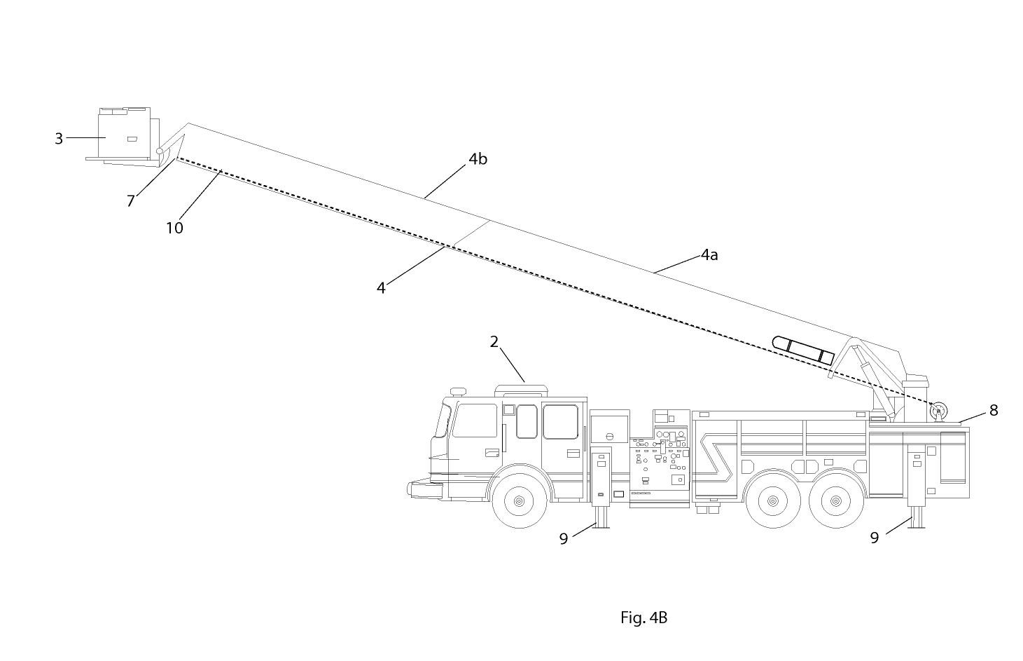

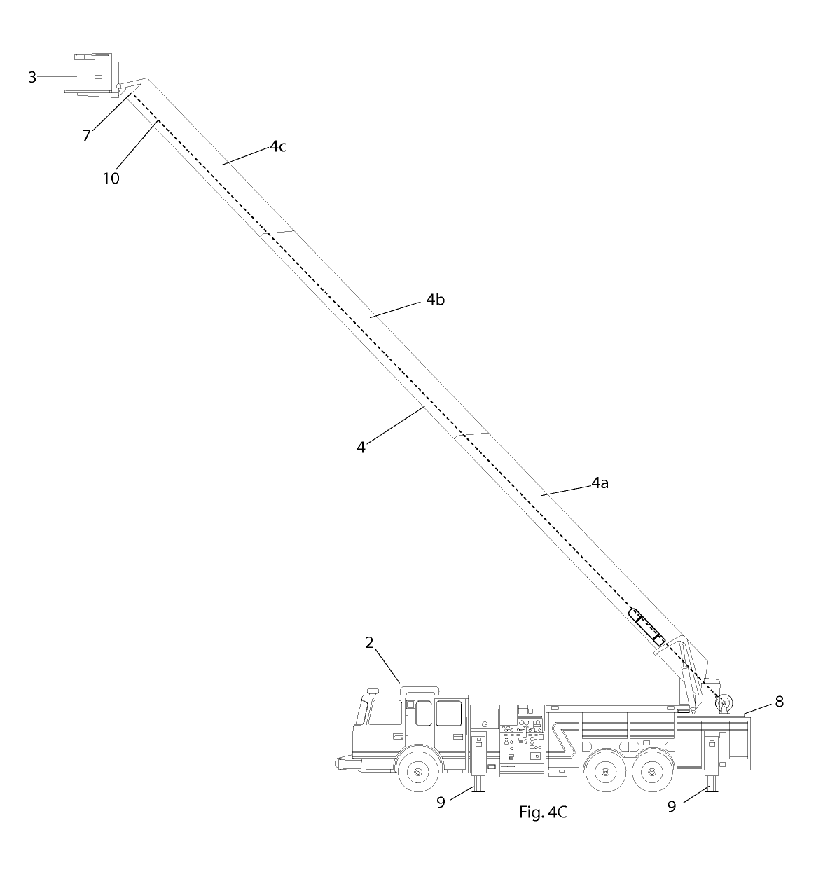

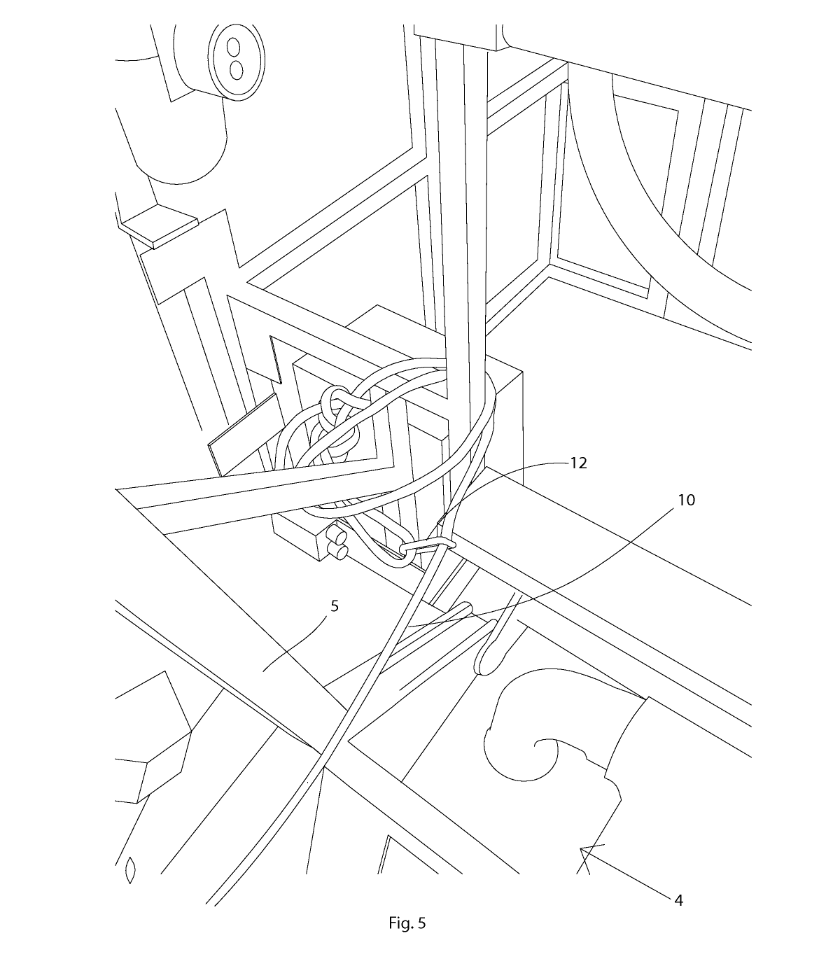

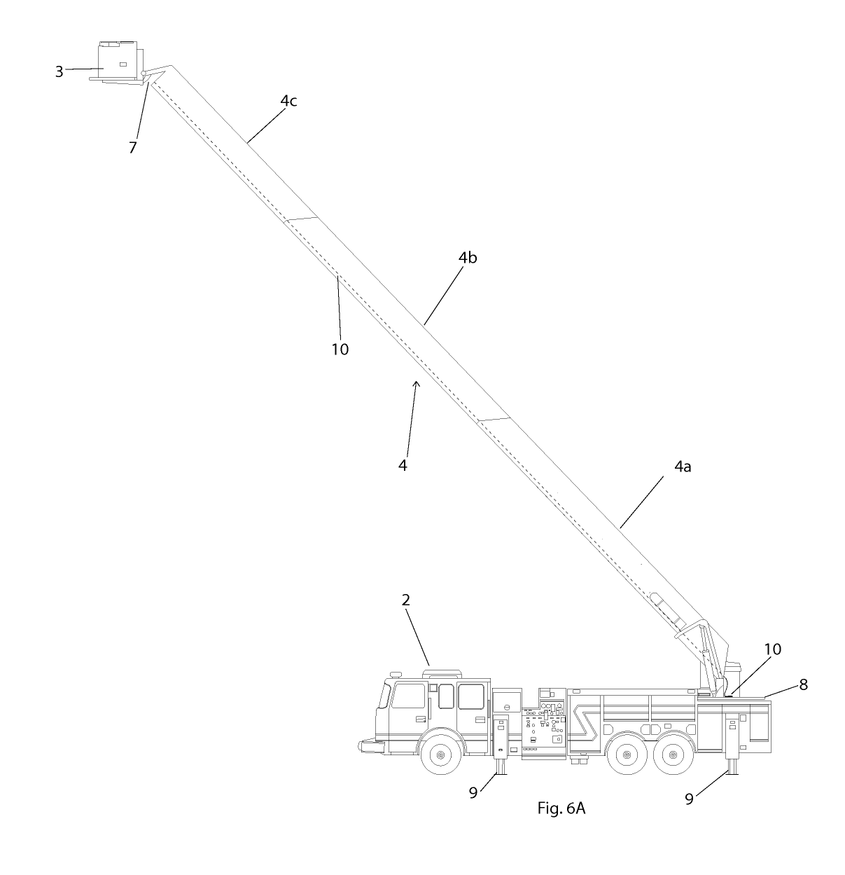

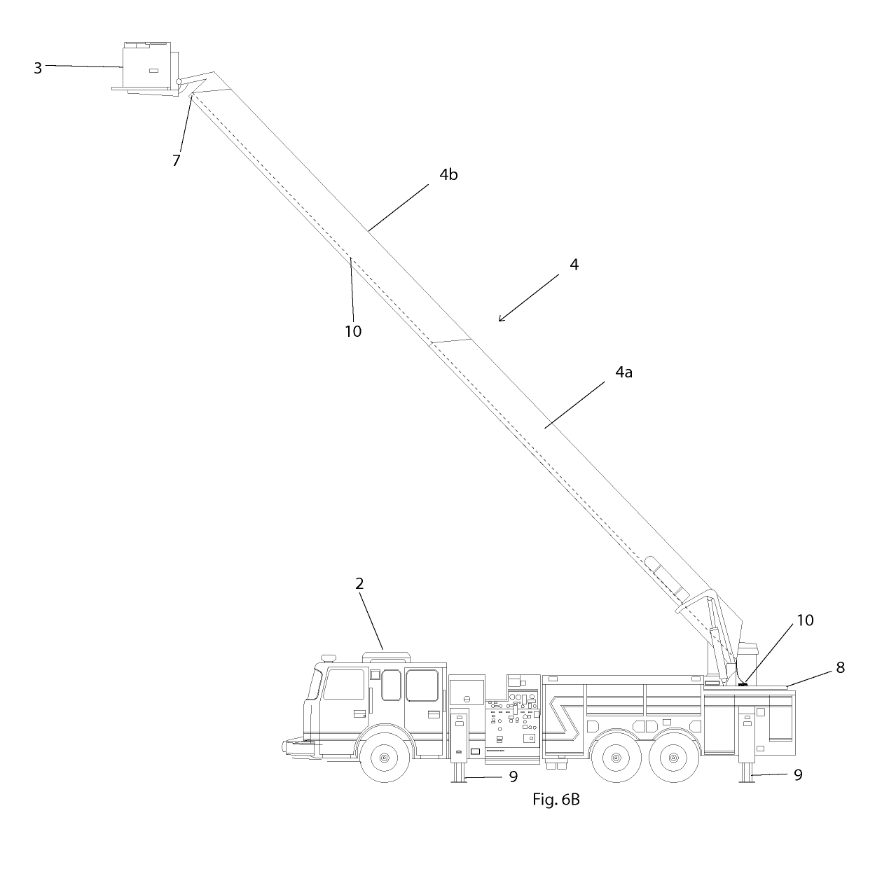

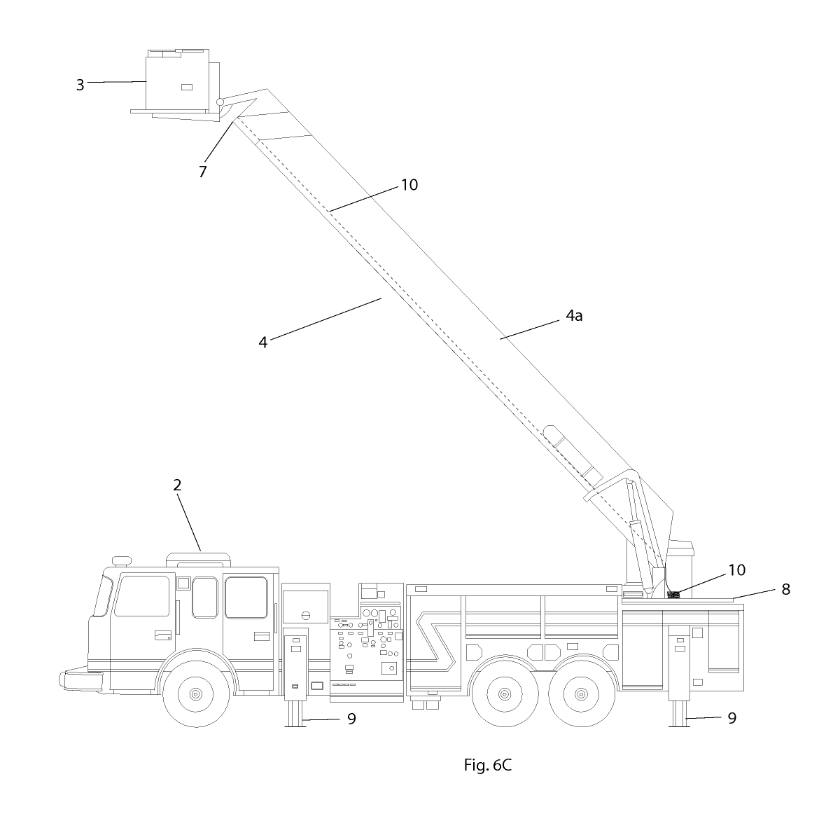

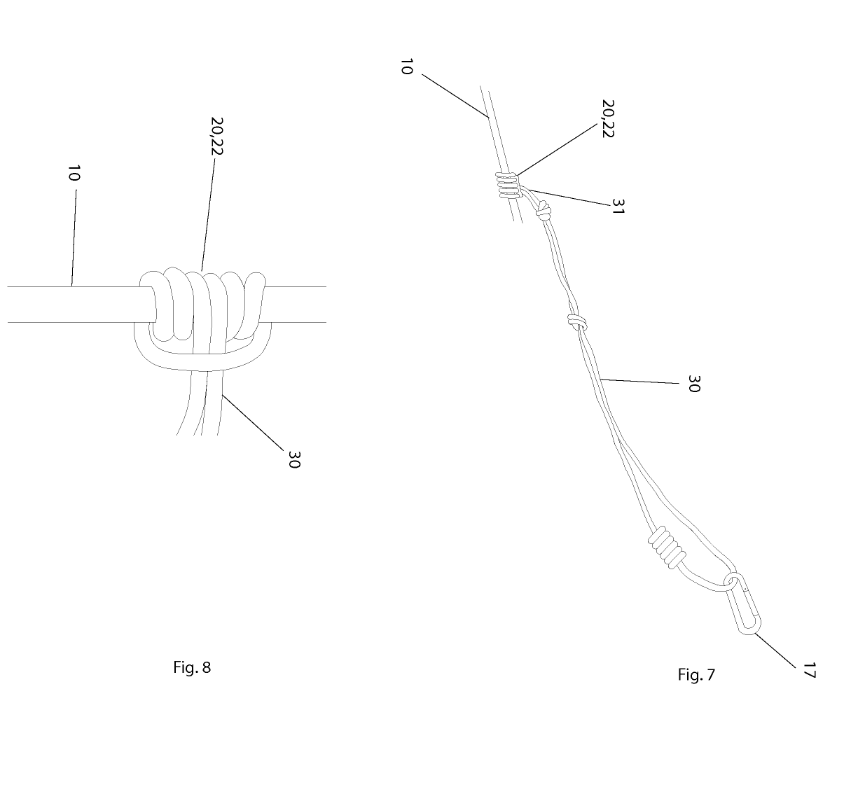

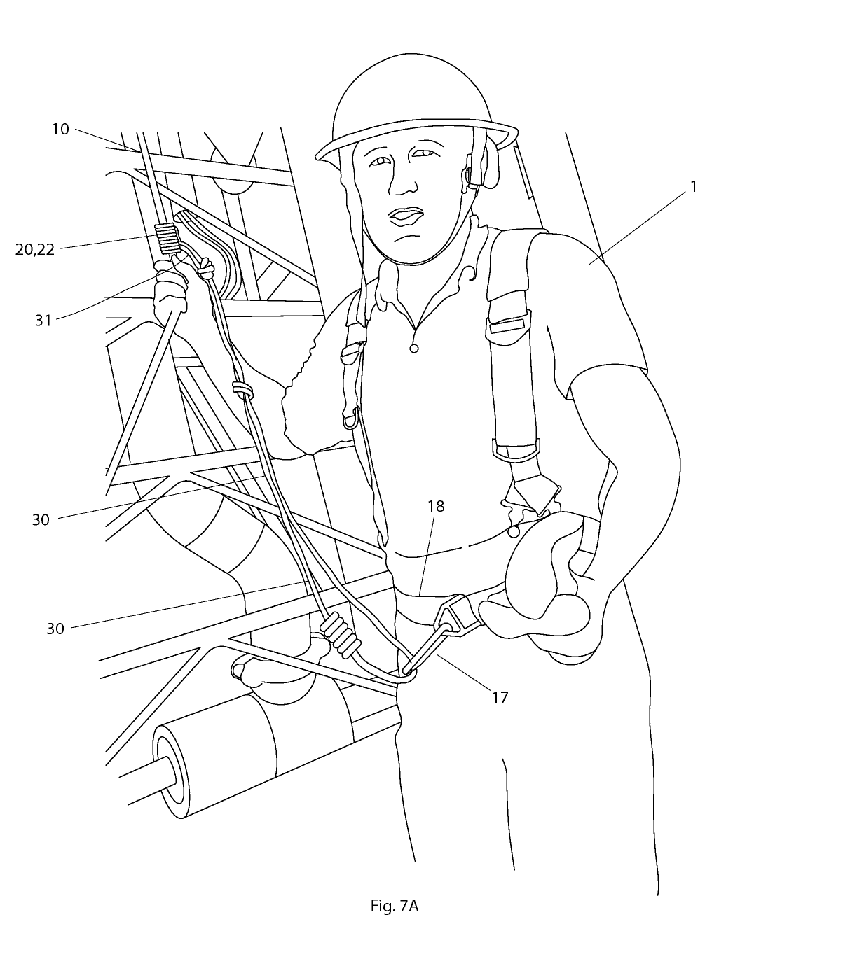

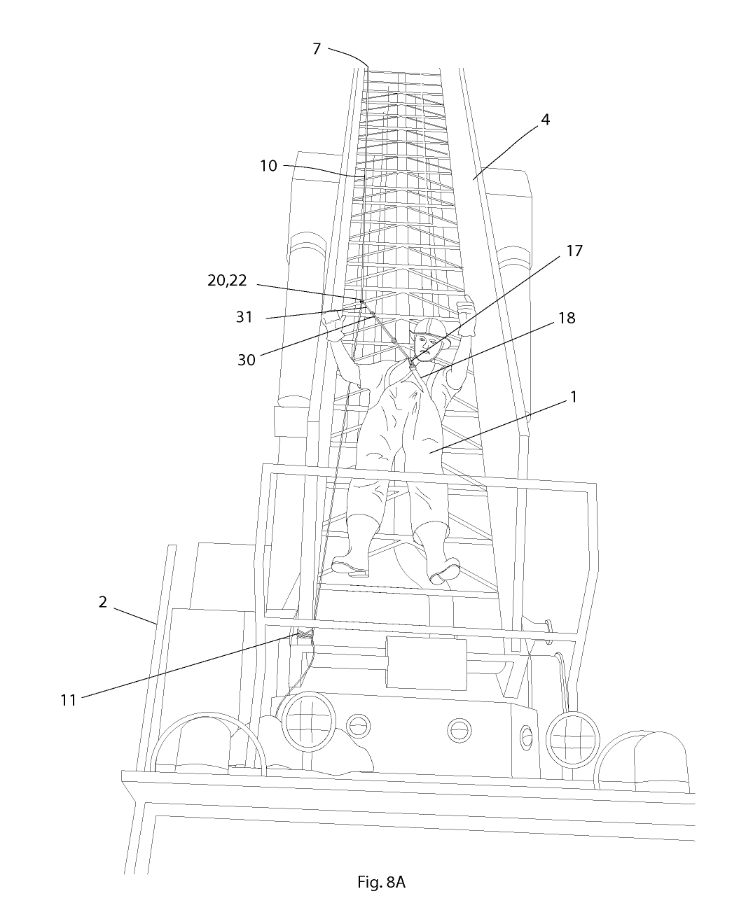

With reference to FIGS. 4A, 4B and 4C, the ladder 4 is shown sequentially being extended. Initially, the ladder 4 is oriented vertically or almost vertically with all the sections stacked. As shown in FIG. 5, the rope 10 is attached using a carabiner 12 or other clasp mechanism to the top of the ladder 4 preferably along one of the handrail 5 sides or the other. The rope 10 lies on the exposed rungs 6 and has a sufficient amount of length L to allow the ladder 4 to extend as the first section extends outwardly, the second underlying section of the ladder 4 is exposed. The rope 10 has a sufficient supply of length L to extend with the ladder as it is being extended upwardly with the rope 10 attached to the top end 7 of the first section 4a of ladder 4. FIG. 4B shows the second section 4b in the extended condition. After this section 4b is extended, the third section 4c extends upwardly and the rope 10 is shown extending from the top end 7 all the way to the base 8 of the ladder 4. Preferably, the rope 10 is held in such a condition that in the fully upright position it is taut. The rope 10 is preferably held with some resistance between the top end 7 and the bottom or base 8 along the entire extension of the rope 10. At this point, the safety rope 10 is in orientation to facilitate a climber 1. To facilitate the climber 1, the climber 1 will wear a lanyard 30 around his waist or harness belt 18 such that the lanyard 30 can be connected to the safety rope 10. Preferably the connection of the lanyard 30 is done using a locking device 20 that is normally held in an open unlocked position such that it can move freely up and down the safety rope 10 as the climber climbs the ladder 4. As the climber 1 approaches the extended vertical ladder 4, he must attach his lanyard 30 about the safety rope 10 and secure it to his waist belt 18, preferably with a clasp 17 as shown in FIGS. 7A and 8A. Upon doing so, the climber 1 is now safely secured to the safety rope 10 and can climb the ladder 4 rapidly as he ascends to the top. Once the climber 1 is climbing, should he slip or fall in any fashion, the end 31 of the lanyard 30 with the locking device 20 attached to the safety rope 10 will stop his descent shown in FIG. 8A. This stopping of a climber 1 from falling is provided by a locking element 20 attached to the end 31 of a lanyard 30.

As shown in FIG. 7, and more particularly, FIG. 8, an enlarged view of the lanyard 30 is shown wherein the locking element 20 is shown as a PRUSIK device 20. A PRUSIK device 20 is a locking element 20 that is formed by a specific wrapping of the lanyard 30 about the safety rope 10 forming a knot 22 in the lanyard 30. This PRUSIK knot 22 as shown is a triple wrap knot 22 which enables the lanyard 30 to slide freely up and down the rope 10, however, in the event of a load being applied to the lanyard 30 such as in a fall condition, the PRUSIK knot 22 will collapse upon itself creating a locking resistance from further movement upon the rope 10. This provides the needed safety feature that will protect a firefighter 1 climbing the ladder 4 in an event he should slip or fall whether climbing up or coming down the ladder 4. This is extremely important because the firefighter 1, who has now lost his balance going up or coming down the ladder 4 can fall, but be safely assured that the lanyard 30 and rope 10 will secure him and prevent further slipping as shown in FIG. 8A. The firefighter 1 may fall approximately a foot or slightly more dependent on the length of the lanyard 30 attached to the ladder 4 prior to the locking element 20 activating. The locking element activates automatically upon a load or force being applied to the lanyard 30. This enables the firefighter 1 to move freely up or down the ladder 4 without impeding his ascent or descent. His hands are free and he can safely climb the ladder 4 without any interference from the safety rope 10 device.

Importantly, when the safety rope 10 is fixed to the top end 7 of the ladder 4 adjacent the platform 3, it preferably should also be secured somewhere along the bottom of the ladder 4. This can be done, as shown in FIG. 8A, by a clamping of a bottom end 11 of the rope 10 such that it has a proper length to allow for the full extension of the ladder 4 and yet will remain tightly secured to the ladder 4. This facilitates the climbing as the lanyard 30 slides on the rope 10 to enable the locking end knot 22 to freely move. When the ladder 4 is needed to be refracted as the climbers 1 are off the ladder 4, it is important that the safety rope 10 follows the refraction of the ladder sections 4a, 4b and 4c in such a way that the rope 10 does not get entangled in the ladder sections 4a, 4b and 4c. To accomplish this, the weight of the rope 10 is sufficient that the rope will lie against the exposed outer rungs 6 of the ladder 4 as it is being refracted. As the safety rope 10 falls it piles at the base 8 of the ladder 4. Once fully refracted, and the ladder 4 is ready to be loaded in the horizontal position, the firefighters 1 can detach the top end of the rope 10 at the carabiner 12 and at the bottom end 11 of the rope 10 and stow the entire safety rope 10 in a bag 13 for later storage, see FIG. 10A.

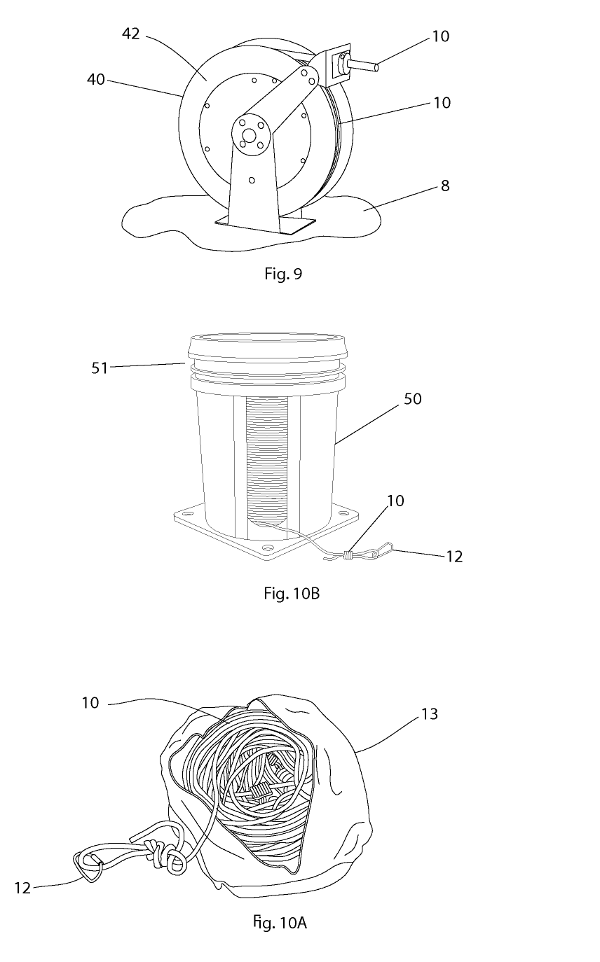

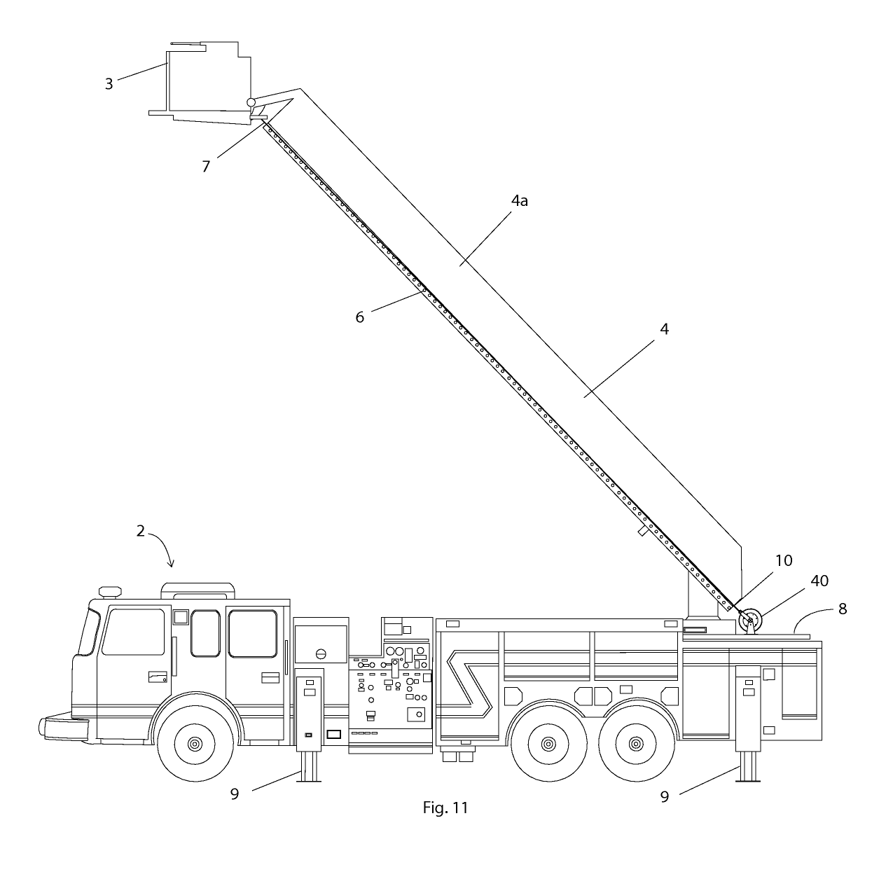

More preferably, as shown in FIGS. 9 and 11, at the base 8 of the ladder 4 it is preferable that the entire safety rope be placed upon a manual spool 40. This manual spool 40 preferably has a winding wheel 42 that allows the rope 10 to be rewound onto the spool 40 as the ladder 4 is being retracted. Under normal conditions, the rope 10 will feed from the spool 40 as the ladder 4 extends upwardly. Preferably, the spool 40 has a spring tension mechanism that provides a sufficient tautness on the rope 10 such that when attached to the bottom of the ladder, as the ladder extends, the rope 10 remains taut through the extension of each of the sections 4a, 4b and 4c until the rope 10 and ladder 4 reach full extension. In this way, the climber 1 is safely secured to the rope 10 which is affixed at one end 7 by the carabiner 12 at the top and at the lower end 11 by the spool 40 at the bottom or base 8. As shown, the spool 40 preferably can be detached from the ladder 4 upon full retraction of the ladder 4 such that the spool 40 with the wound safety rope 10 upon it can be stowed in the vehicle 2.

In an alternative embodiment shown in FIG. 10B, a spool 50 has an automatic refractor 51. In this fashion, the rope 10 may be automatically wound back onto the spool 50, and will feed automatically onto the spool reel as a spring loaded retractor 51 pulls on the rope 10 constantly as the ladder sections 4a, 4b and 4c are being retracted. In this embodiment, the spool 50 preferably is also detachable from the base 8 of the ladder 4 for storage.

As shown, it is believed important that the safety rope 10 be a static kernmantle rope preferably having a diameter of ½″/12.5 mm or greater and breaking strength of at least 9,000 lbs, a length of 75 to 150 feet or whatever length is needed for the full extension of the ladder 4. Typically these ladders 4 extend 75 to 100 feet or more, sometimes 130 to 150 feet in length. It is preferred that the rope 10 be of sufficient length that it is able to accommodate whatever length of ladder 4 is required. As shown, the end of the rope 10 has a carabiner 12 or quick release mechanism 12 or other attachment clasp or fastener 12 attached so that the rope 10 can be attached to a top end 7 of the ladder 4 and be allowed to be affixed there. Once the ladder 4 is refracted, this attachment or fastener can be unfastened in order to stow the safety rope 10 and spool 40, 50 if used.

Furthermore, as shown, the locking device 20 used on the lanyard 30 tying the climber 1 to the safety rope 10 and attached to the climber 1 through his waist belt 18 or other harness can be any locking mechanism 20 that allows free movement of the climber 1, but will lock onto the rope 10 in the event he should fall and a force be applied to the lanyard 30 such that it triggers the locking element 20 to clamp or clinch onto the rope 10 preventing further sliding downwardly.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described, which will be within the full intended scope of the invention as defined by the following appended claims.

What is claimed is:

1. A fall restraint device for attachment to an extendable or telescoping ladder platform, the device comprises:
a safety rope, having a first end for attachment to an anchor point on a side of the ladder at an end or top of the ladder and a second end located at or near the base of the ladder held on the same side as the first end;
and wherein the length of the rope lays on tops of the exposed rungs of the ladder and extends with the ladder as the ladder is deployed.

2. The fall restraint device of claim 1 wherein upon retraction of the ladder the weight of the rope follows the ladder and drops toward the base or turntable of the ladder.

3. The fall restraint device of claim 1 wherein the rope piles at the base of the ladder and is unsecured from the ladder at the first end and placed in a rope bag or storage container after use.

4. The fall restraint device of claim 3 wherein the second or bottom end of said rope is held taut or otherwise affixed at or near the bottom or base of the ladder.

5. The fall restraint device of claim 1 wherein the second or bottom end of the rope is affixed to a windable spool.

6. The fall restraint device of claim 5 wherein the spool is manually wound.

7. The fall restraint device of claim 6 has a wind up reel for manual winding of the rope back onto the spool.

8. The fall restraint device of claim 7 wherein the spool includes a spring loaded retractable rope spool.

9. The fall restraint device of claim 8 wherein the spring tension provides continuous tension or tautness on the rope.

10. The fall restraint device of claim 9 wherein the spool has a spring loaded retractor reel for automatically winding the rope.

11. The fall restraint device of claim 10 wherein the spool is removably attached to the bottom of the ladder.

12. The fall restraint device of claim 11 wherein the spool with the wound rope is detached from the ladder for stowing.

13. The fall restraint device of claim 1 further comprises:
a lanyard for attachment to a climber of the ladder and for slidable attachment to the safety rope.

14. The fall restraint device of claim 13 wherein the lanyard has a locking element at the slidable attachment to the rope, the locking element locks the lanyard to the safety rope when under load of a falling or slipping climber; and wherein the locking element slides freely unloaded.

15. The fall restraint device of claim 14 wherein the locking element is a PRUSIK device.

16. The fall restraint device of claim 15 wherein the PRUSIK device is a PRUSIK knot in the lanyard.

17. The fall restraint device of claim 16 wherein the PRUSIK knot is triple wrapped.
